(19) United States
(12) Patent Application Publication
(10) Pub. No.: US 2002/0003447 A1
(43) Pub. Date: Jan. 10, 2002

(54) Trimming circuit of semiconductor integrated device

(75) Inventors: Naoki Nagase, Kasugai-shi (JP); Hidenobu Ito, Kasugai-shi (JP)

Correspondence Address: ARENT FOX KINTNER PLOTKIN & KAHN, 1050 CONNECTICUT AVENUE, N.W., SUITE 600, WASHINGTON, DC, 20036, US

(73) Assignee: FUJITSU LIMITED

(21) Appl. No.: 09/769,241

(22) Filed: Jan. 26, 2001

(30) Foreign Application Priority Data
Jul. 4, 2000 (JP) 2000-202182

(51) Int. Cl. H02J 3/38

(52) U.S. Cl. 327/530

(57) ABSTRACT

A trimming circuit, the resistance of which can be increased or decreased. The trimming circuit has a first circuit, which includes a first resistor and a Zener diode connected in parallel to the first resistor, and a second circuit, which includes a second resistor and a fuse connected in parallel to the second resistor. The second circuit is connected in series to the first circuit. The resistance of the trimming circuit is decreased by performing trimming with the Zener diode and is increased by performing trimming with the fuse.

### BACKGROUND OF THE INVENTION

The present invention relates to semiconductor devices, and more particularly, to a trimming circuit that adjusts the resistance of a semiconductor integrated device.

The resistance of a semiconductor integrated circuit is adjusted so that it matches a target resistance value. To adjust the resistance with high accuracy, the semiconductor integrated circuit is provided with a highly accurate trimming circuit.

FIG. 1 illustrates a first prior art example of a two-bit Zener zap trimming circuit E used in a semiconductor integrated circuit. The trimming circuit E is connected between resistors R0, R3 and includes two parallel circuits connected between the resistors R0, R3 and three trimming terminals T1, T2, T3. In more detail, the first parallel circuit includes an upstream resistor R1 and a first Zener diode Z2, which is connected in parallel to the upstream resistor R1. The second parallel circuit includes a downstream resistor R2 and a second Zener diode Z2, which is connected in parallel to the downstream resistor R2. The four resistors R0, R1, R2, R3 are connected in series. When a high voltage is applied to two of the trimming terminals T1, T2, T3, a breakdown occurs in the associated one of the first and second Zener diodes Z1, Z2. This causes the associated one of the first and second Zener diodes Z1, Z2 to become conductive.

When adjusting the resistance of the semiconductor integrated circuit, the breakdown voltage is applied to one or both of the first and second Zener diodes Z1, Z2. This causes the first and second Zener diodes Z1, Z2, to which the breakdown voltage is applied, to become conductive and decreases the voltage of the trimming circuit E.

FIG. 2 illustrates a second prior art example of a two-bit fuse trimming circuit F used in a semiconductor integrated circuit. The trimming circuit F includes a first fuse F1 and a second fuse F2 in lieu of the Zener diodes Z1, Z2 of the trimming circuit E of FIG. 1. The resistance of the first fuse F1 is significantly lower than that of an upstream resistor R1, and the resistance of the second fuse F2 is significantly lower than that of a downstream resistor R2.

When adjusting the resistance of the semiconductor integrated circuit, a fusing current is supplied to at least one of the first and second fuses F1, F2. This breaks the at least one of the fuses F1, F2 and increases the resistance of the trimming circuit F.

The Zener ZAP trimming circuit E of FIG. 1 is capable of only decreasing the resistance. Thus, the initial resistance of the trimming circuit E is set higher than the target resistance.

On the other hand, the fuse trimming circuit F of FIG. 2 is capable of only increasing the resistance. Thus, the initial resistance of the trimming circuit F is set lower than the target resistance.

Accordingly, the trimming circuits E, F of FIGS. 1 and 2 are capable of either increasing or decreasing the resistance. However, the trimming circuits E, F are not capable of adjusting the resistance in both increasing and decreasing directions. Further, the initial resistance is always greater than or less that the target resistance to enable trimming. As a result, trimming must always be performed to adjust the resistance.

### SUMMARY OF THE INVENTION

It is an object of the present invention to provide a trimming circuit capable of increasing and decreasing the resistance.

To achieve the above object, the present invention provides a trimming circuit having an initial resistance. The trimming circuit has a first circuit, which includes a first resistor and a first resistance adjustment device connected in parallel to the first resistor, and a second circuit, which includes a second resistor and a second resistance adjustment device connected in parallel to the second resistor. The second circuit is connected in series to the first circuit. The resistance of the trimming circuit is decreased to a value lower than the initial resistance by performing trimming with the first resistance adjustment device and is increased to a value higher than the initial resistance by performing trimming with the second resistance adjustment device.

The present invention also provides a trimming circuit having an initial resistance. The trimming circuit has a first resistor and a first circuit connected in parallel to the first resistor. The first circuit includes a first auxiliary resistor and a first resistance adjustment device that are connected in series. The trimming circuit also has a second resistor and a second circuit connected in parallel to the second resistor. The second circuit includes a second auxiliary resistor and a second resistance adjustment device that are connected in series. The resistance of the trimming circuit is decreased to a value lower than the initial resistance by performing trimming with the first resistance adjustment device and is increased to a value higher than the initial resistance by performing trimming with the second resistance adjustment device.

The present invention further provides a semiconductor integrated circuit device including a trimming circuit having an initial resistance. The trimming circuit has a first circuit, which includes a first resistor and a first resistance adjustment device connected in parallel to the first resistor, and a second circuit, which includes a second resistor and a second resistance adjustment device connected in parallel to the second resistor. The second circuit is connected in series to the first circuit. The resistance of the trimming circuit is decreased to a value lower than the initial resistance by performing trimming with the first resistance adjustment device and is increased to a value higher than the initial resistance by performing trimming with the second resistance adjustment device.

The present invention further provides a trimming circuit having an initial resistance. The trimming circuit has a plurality of trimming terminals including a first trimming terminal, a second trimming terminal, and a third trimming terminal. A first resistor is connected between the first trimming terminal and the second trimming terminal. A Zener diode is connected in parallel to the first resistor between the first and second trimming terminals. A second resistor is connected in series to the first resistor between the second trimming terminal and the third trimming terminal. A fuse is connected in parallel to the second resistor and in series to the Zener diode between the second and third trimming terminals. The resistance of the trimming circuit is decreased to a value lower than the initial resistance by applying a breakdown voltage of the Zener diode between the first and second trimming terminals, and the resistance of the trimming circuit is increased to a value higher than the initial resistance by supplying a fusing current of the fuse between the second and third trimming terminals.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic circuit diagram of a prior art Zener zap trimming circuit;

FIG. 2 is a schematic circuit diagram of a prior art fuse trimming circuit;

FIG. 3 is a schematic circuit diagram of a trimming circuit according to a first embodiment the present invention;

FIG. 4 is a schematic circuit diagram of a trimming circuit according to a second embodiment of the present invention;

FIG. 5 is a schematic circuit diagram of a trimming circuit according to a third embodiment of the present invention; and

FIG. 6 is a schematic circuit diagram of a trimming circuit according to a fourth embodiment of the present invention.

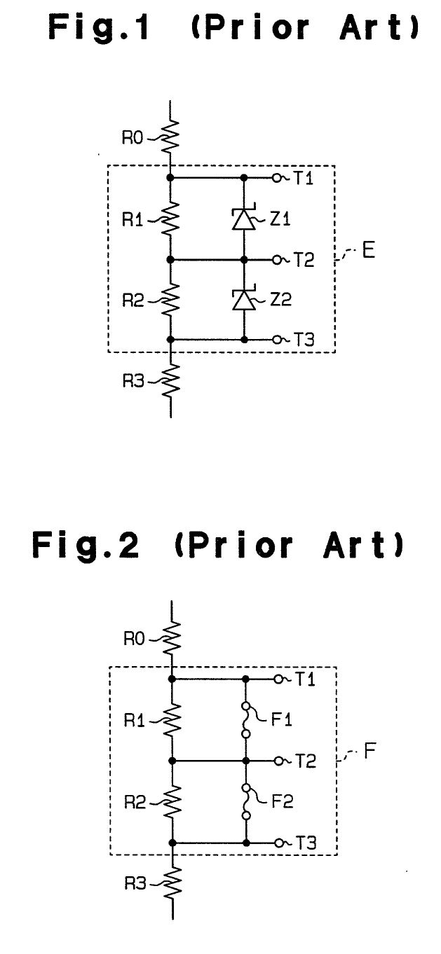

### DETAILED DESCRIPTION OF THE PREFERRED EMBODIMENTS

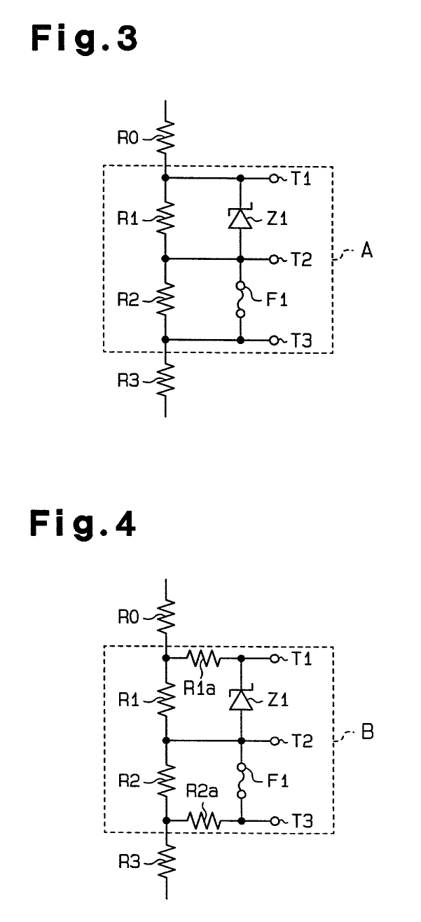

With reference to FIG. 3, a trimming circuit A according to a first embodiment of the present invention includes a first resistor R1, a second resistor R2, a Zener diode Z1, which functions as a first resistance adjustment device, and a fuse F1, which functions as a second resistance adjustment device. The Zener diode Z1 is connected in parallel to the first resistor R1. The fuse F1 is connected in parallel to the second resistor R2. The two parallel circuits are connected in series between two resistors R0, R3. Application of a breakdown voltage to the Zener diode Z1 causes the Zener diode Z1 to be conductive. The supply of a fusing current to the fuse F1 breaks and causes the fuse F1 to be non-conductive.

The trimming circuit A enables the total resistance of the trimming circuit A to increase and decrease. More specifically, when the resistance of the trimming circuit A prior to trimming is higher than a desired resistance, a breakdown voltage is applied to the Zener diode Z1. If the resistance of the trimming circuit A prior to trimming is lower than a desired resistance, a fusing current is supplied to the fuse F1. Accordingly, the trimming circuit A of the first embodiment adjusts the resistance of the trimming circuit A in both increasing and decreasing directions. Thus, the resistance is variable in a bidirectional manner.

A trimming circuit B according to a second embodiment of the present invention will now be discussed with reference to FIG. 4.

The trimming circuit B has an upstream circuit and a downstream circuit connected in series between a resistor R0 and a resistor R3. The upstream circuit includes a first resistor R1, a Zener diode Z1, and an upstream resistor R1a, which is connected in series between the first resistor R1 and the Zener diode Z1. The downstream circuit includes a second resistor R2, a fuse F1, and a downstream resistor R2a, which is connected in series between the second resistor R2 and the fuse F1. The resistance of the fuse F1 is significantly smaller than the resistances of the resistors R2, R2a. The resistor R1 is connected to the resistor R0, and the resistor R2 is connected to the resistor R3. The application of a breakdown voltage between the trimming terminals T1, T2 results in breakdown of the Zener diode Z1 and causes the Zener diode Z1 to become conductive. The supply of a fusing current to the fuse F1 breaks the fuse F1. This causes the fuse F1 to become non-conductive.

Prior to trimming, that is, in an untrimmed state, the Zener diode Z1 is non-conductive and the fuse F1 is conductive.

When the resistances of the resistors R1, R1a, R2, R2a, and the fuse F1 are represented by r1, r1a, r2, r2a, f1 (f1<<r2, r2a), respectively, and the resistance f1 is so small that it can be ignored, the resistance (initial resistance) of the trimming circuit B in an untrimmed state is expressed by formula (1).

r1+(r2×r2a)÷(r2+r2a) (1)

To decrease the resistance of the trimming circuit B, a breakdown voltage is applied to the Zener diode Z1. This causes the Zener diode Z1 to become conductive. In this case, the resistance of the trimming circuit B subsequent to trimming is expressed by formula (2).

(r1×r1a)÷(r1+r1a)+(r2×r2a)÷(r2+r2a) (2)

To increase the resistance of the trimming circuit B, a fusing current is supplied to the fuse F1. This breaks the fuse F1 and causes the fuse F1 to be non-conductive. In this case, the resistance of the trimming circuit B subsequent to trimming is expressed by formula (3).

r1+r2 (3)

When finely adjusting the initial resistance, a breakdown voltage is applied to the Zener diode Z1 to cause the Zener diode Z1 to become conductive, and a fusing current is supplied to the fuse F1 to break and cause the fuse F1 to become non-conductive. In this case, the resistance of the trimming circuit subsequent to trimming is expressed by formula (4).

(r1×r1a)÷(r1+r1a)+r2 (4)

The trimming circuit B of the second embodiment has the advantages described below.

(1) In the trimming circuit B, the fuse 1 increases the resistance from the initial resistance and the Zener diode Z1 decreases the resistance from the initial resistance. Thus, the fuse 1 and the Zener diode Z1 enable the initial resistance to be set to substantially match the target resistance from the beginning. If the initial resistance matches the target resistance, trimming need not be performed. Further, the fuse 1 and the Zener diode Z1 enable the resistance to be varied from the initial resistance when necessary.

(2) By performing trimming with the Zener diode Z1 and the fuse F1, fine adjustment of the resistance with the upstream resistor R1a, which is series-connected to the Zener diode Z1, is enabled.

(3) Since the resistance can be varied (increased and decreased) as desired, semiconductor integrated circuit devices are manufactured with improved accuracy and an increased yield. Further, the testing time required until completing incorporation to, for example, a power supply IC circuit is decreased.

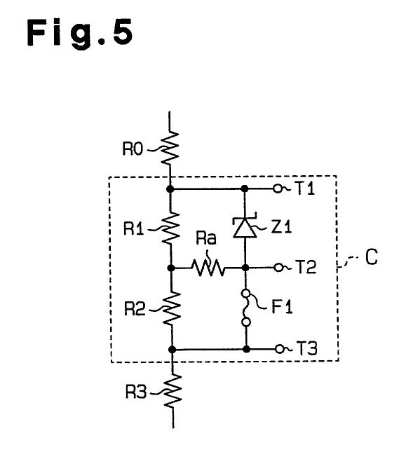

A trimming circuit C according to a third embodiment of the present invention will now be discussed with reference to FIG. 5. The trimming circuit C uses an intermediate resistor Ra in lieu of the upstream and downstream resistors R1a, R2a of the second embodiment. The intermediate resistor Ra is connected between a trimming terminal T2 and a node between resistors R1, R2. The resistance of the intermediate resistor Ra is significantly greater than the resistance of the fuse F1.

When the resistance of the intermediate resistor Ra is represented by ra and the resistance of the fuse F1 is so small that it can be ignored, the initial resistance of the trimming circuit C is expressed by formula (5).

r1+(r2×ra)÷(r2+ra) (5)

To decrease the resistance, trimming is performed with the Zener diode Z1. This causes the resistance of the trimming circuit C to be substantially null.

To increase the resistance, trimming is performed with the fuse F1. In this case, the resistance of the trimming circuit C subsequent to the trimming is expressed by formula (6).

r1+r2 (6)

To finely adjust the resistance of the trimming circuit C, trimming is performed with the Zener diode Z1 and the fuse F1. In this case, the resistance of the trimming circuit C is expressed by formula (7).

(r2×ra)÷(r1+ra)+r2 (7)

The trimming circuit C of the third embodiment has the advantages described below.

(1) Trimming may be performed with the Zener diode Z1. This enables the resistance of the trimming circuit C to become substantially null.

(2) Trimming may be performed with the Zener diode Z1 and the fuse F1. This enables fine adjustment of the resistance with the intermediate resistor Ra, which is series-connected to the Zener diode Z1.

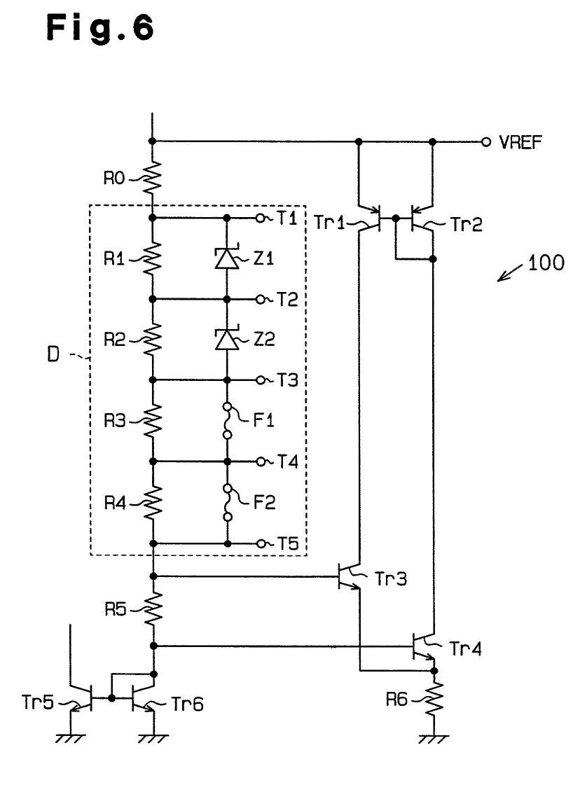

A trimming circuit D according to a fourth embodiment of the present invention will now be discussed with reference to FIG. 6. The trimming circuit D is connected to a reference voltage circuit 100. The reference voltage circuit 100 includes PNP transistors Tr1, Tr2, NPN transistors Tr3-Tr6, and resistors R0, R5, R6. The trimming circuit D is connected between the resistors R0, R5.

The trimming circuit D is a two-bit trimming circuit configured by a two-bit Zener zap trimming circuit and a two-bit fuse trimming circuit. The Zener zap trimming circuit includes a first resistor R1, a second resistor R2, a first Zener diode Z1, and a second Zener diode Z2. The fuse trimming circuit includes a third resistor R3, a fourth resistor R4, a first fuse F1, and a second fuse F2.

The resistance of the first fuse F1 is significantly lower than the resistance of the third resistor R3. The resistance of the second fuse F2 is significantly lower than the resistance of the fourth resistor R4. Application of a breakdown voltage between the trimming terminals T1, T2 causes the first Zener diode Z1 to become conductive. Application of a breakdown voltage between the trimming terminals T2, T3 causes the second Zener diode Z2 to become conductive. The supply of a fusing current between the trimming terminals T3, T4 breaks and causes the first fuse F1 to become non-conductive. The supply of a fusing current between the trimming terminals T4, T5 breaks and causes the second fuse F2 to become non-conductive.

When the resistances of the resistors R1, R2, R3, R4 are represented by 4r, r, 2r, 8r, respectively, and the resistance f1 of the fuse F1 and the resistance f2 of the fuse F2 are so small that they can be ignored, the initial resistance of the trimming circuit D is expressed by equations (8) to (22).

The resistance of the trimming circuit D when performing trimming with the fuses F1, F2 is expressed by equation (8).

R1+R2+R3+R4=15r (8)

The resistance of the trimming circuit D when performing trimming with the fuses F1, F2 and the Zener diode Z2 is expressed by equation (9).

R1+R3+R4=14r (9)

The resistance of the trimming circuit D when performing trimming with the fuse F2 is expressed by equation (10).

R1+R2+R4=13r (10)

The resistance of the trimming circuit D when performing trimming with the fuse F2 and the Zener diode Z2 is expressed by equation (11).

R1+R4=12r (11)

The resistance of the trimming circuit D when performing trimming with the fuses F1, F2 and the Zener diode Z1 is expressed by equation (12).

R2+R3+R4=11r (12)

The resistance of the trimming circuit D when performing trimming with the fuses F1, F2 and the Zener diodes Z1, Z2 is expressed by equation (13).

R3+R4=10r (13)

The resistance of the trimming circuit D when performing trimming with the fuse F2 and the Zener diode Z1 is expressed by equation (14).

R2+R4=9r (14)

The resistance of the trimming circuit D when performing trimming with the fuse F2 and the Zener diodes Z1, Z2 is expressed by equation (15).

R4=8r (15)

The resistance of the trimming circuit D when performing trimming with the fuse F1 is expressed by equation (16).

R1+R2+R3=7r (16)

The resistance of the trimming circuit D when performing trimming with the fuse F1 and the Zener diode Z2 is expressed by equation (17).

R1+R3=6r (17)

The resistance of the trimming circuit D in an untrimmed state is expressed by equation (18).

R1+R2=5r (18)

The resistance of the trimming circuit D when performing trimming with the Zener diode Z2 is expressed by equation (19).

R1=4r (19)

The resistance of the trimming circuit D when performing trimming with the fuse F1 and the Zener diode Z1 is expressed by equation (20).

R2+R3=3r (20)

The resistance of the trimming circuit D when performing trimming with the fuse F1 and the Zener diodes Z1, Z2 is expressed by equation (21).

R3=2r (21)

The resistance of the trimming circuit D when performing trimming with the Zener diode Z1 is expressed by equation (22).

R2=r (22)

When trimming is performed with the Zener diodes Z1, Z2, the resistance of the trimming circuit D is substantially null. Accordingly, the resistance of the trimming circuit D is adjustable in sixteen ways.

The trimming circuit D of the fourth embodiment has the advantages described below.

(1) The combination of the two-bit fuse trimming circuit and the two-bit Zener zap trimming circuit in addition to the employment of resistors having different resistances enable fine adjustment of the resistance of the trimming circuit D. In other words, the trimming circuit D is highly accurate.

(2) Trimming may be performed with the Zener diodes Z1, Z2. This enables the resistance of the trimming circuit D to become substantially null.

It should be apparent to those skilled in the art that the present invention may be embodied in many other specific forms without departing from the spirit or scope of the invention. Particularly, it should be understood that the present invention may be embodied in the following forms.

The resistance of each of the resistors used in the above embodiments may be changed as required.

In the fourth embodiment, the resistance of each of the resistors may be changed such that the resistance of the trimming circuit D is increased by performing trimming with the fuses f1, f2 and the resistance of the timing circuit D is decreased by performing trimming with the Zener diodes Z1, Z2.

The number of fuses and Zener diodes may be varied. An increased number of fuses and Zener diodes enables finer adjustment of the resistance when matching the resistance of the semiconductor integrated circuit with the target resistance.

The present examples and embodiments are to be considered as illustrative and not restrictive, and the invention is not to be limited to the details given herein, but may be modified within the scope and equivalence of the appended claims.

What is claimed is:

1. A trimming circuit having an initial resistance, the trimming circuit comprising:
a first circuit including a first resistor and a first resistance adjustment device connected in parallel to the first resistor; and
a second circuit including a second resistor and a second resistance adjustment device connected in parallel to the second resistor, the second circuit being connected in series to the first circuit, wherein the resistance of the trimming circuit is decreased to a value lower than the initial resistance by performing trimming with the first resistance adjustment device and is increased to a value higher than the initial resistance by performing trimming with the second resistance adjustment device.

2. The trimming circuit according to claim 1, wherein the first circuit is one of a plurality of first circuits, and the second circuit is one of a plurality of second circuits, wherein the plurality of first circuits is connected in series with the plurality of second circuits.

3. The trimming circuit according to claim 1, wherein the first resistance adjustment device includes a Zener diode, wherein when a breakdown voltage is applied to the Zener diode, the Zener diode is short-circuited, and the Zener diode decreases the resistance of the trimming circuit when short-circuited.

4. The trimming circuit according to claim 1, wherein the second resistance adjustment device includes a fuse, the fuse being broken by a fusing current, wherein breakage of the fuse increases the resistance of the trimming circuit.

5. A trimming circuit having an initial resistance, the trimming circuit comprising:
a first resistor;
a first circuit connected in parallel to the first resistor, wherein the first circuit includes a first auxiliary resistor and a first resistance adjustment device that are connected in series;
a second resistor; and
a second circuit connected in parallel to the second resistor, wherein the second circuit includes a second auxiliary resistor and a second resistance adjustment device that are connected in series, wherein the resistance of the trimming circuit is decreased to a value lower than the initial resistance by performing trimming with the first resistance adjustment device and is increased to a value higher than the initial resistance by performing trimming with the second resistance adjustment device.

6. The trimming circuit according to claim 5, wherein the first resistance adjustment device includes a Zener diode, wherein when a breakdown voltage is applied to the Zener diode, the Zener diode is short-circuited, and the Zener diode decreases the resistance of the trimming circuit when short-circuited.

7. The trimming circuit according to claim 5, wherein the second resistance adjustment device includes a fuse, the fuse being broken by a fusing current, wherein breakage of the fuse increases the resistance of the trimming circuit.

8. A semiconductor integrated circuit device including a trimming circuit having an initial resistance, the trimming circuit comprising:
a first circuit including a first resistor and a first resistance adjustment device connected in parallel to the first resistor; and
a second circuit including a second resistor and a second resistance adjustment device connected in parallel to the second resistor, the second circuit being connected in series to the first circuit, wherein the resistance of the trimming circuit is decreased to a value lower than the initial resistance by performing trimming with the first resistance adjustment device and is increased to a value higher than the initial resistance by performing trimming with the second resistance adjustment device.

9. A trimming circuit having an initial resistance, the trimming circuit comprising:
a plurality of trimming terminals including a first trimming terminal, a second trimming terminal, and a third trimming terminal;
a first resistor connected between the first trimming terminal and the second trimming terminal;
a Zener diode connected in parallel to the first resistor between the first and second trimming terminals;
a second resistor connected in series to the first resistor between the second trimming terminal and the third trimming terminal; and
a fuse connected in parallel to the second resistor and in series to the Zener diode between the second and third trimming terminals, wherein the resistance of the trimming circuit is decreased to a value lower than the initial resistance by applying a breakdown voltage of the Zener diode between the first and second trimming terminals, and the resistance of the trimming circuit is increased to a value higher than the initial resistance by supplying a fusing current of the fuse between the second and third trimming terminals.

10. The trimming circuit according to claim 9, further comprising:
a first auxiliary resistor connected between the first trimming terminal and the first resistor, wherein a first node between the first trimming terminal and the first auxiliary terminal is connected to the Zener diode; and
a second auxiliary resistor connected between the third trimming terminal and the second resistor, wherein a second node between the third trimming terminal and the second auxiliary resistor is connected to the fuse.

11. The trimming circuit according to claim 9, further comprising:
a common auxiliary resistor connected to a third node between the first and second resistors and to a fourth node between the Zener diode and the fuse.
